(19) United States
(12) Patent Application Publication
(10) Pub. No.: US 2020/0130416 A1
(43) Pub. Date: Apr. 30, 2020

(54) PNEUMATIC TIRE

(71) Applicant: TOYO TIRE CORPORATION, Itami-shi (JP)

(72) Inventor: Seiji Yokomakura, Itami-shi (JP)

(73) Assignee: TOYO TIRE CORPORATION, Itami-shi (JP)

(21) Appl. No.: 16/535,716

(22) Filed: Aug. 8, 2019

(30) Foreign Application Priority Data
Oct. 26, 2018 (JP) 2018-202070
May 7, 2019 (JP) 2019-087805

(51) Int. Cl. B60C 11/00

(52) U.S. Cl. CPC B60C 11/005; B60C 2013/006; B60C 2011/0025; B60C 2011/0033

(57) ABSTRACT

An intersection point between an interface between a cap rubber layer and a base rubber layer and an outermost belt lateral reference line extending from an outer end of an outermost belt is positioned on an inner side in a tire axial direction than an intersection point between a normal line extending from an outer end of a widest belt to the tread surface and the outermost belt lateral reference line. An outer end of the cap rubber layer is terminated on an inner side in a tire radial direction than an outer end of the base rubber layer, and the outer end of the base rubber layer is positioned on an outer side in the tire axial direction than an end of the tread surface.

### CROSS-REFERENCE TO RELATED APPLICATIONS

This application is based upon and claims the benefit of priority from the prior Japanese Patent Applications No. 2018-202070, filed on Oct. 26, 2018 and No. 2019-87805, filed on May 7, 2019; the entire contents of which are incorporated herein by reference.

### BACKGROUND OF THE INVENTION

### 1. Field of the Invention

An embodiment of the present invention relates to a pneumatic tire.

### 2. Description of Related Art

In pneumatic tires fitted to vehicles such as a truck or bus, it is known that a tread rubber is formed by a two-layer structure including a cap rubber layer forming a tread surface and a base rubber layer arranged on an inner side in a radial direction thereof for realizing both wear resistance and a low-fuel consumption property. Rubber having excellent wear resistance is used for the cap rubber layer and rubber having a low-heat generation property with a low loss tangent tan δ is used for the base rubber layer.

For example, in JP-A-2007-137411 (Patent Literature 1), there is described an invention in which a ratio of the base rubber layer with the low-heat generation property occupying a shoulder section where heat generation is the highest in a tread section is increased and a thickness of the cap rubber layer is increased at a tread central region so as to be higher than a thickness of the cap rubber layer at the shoulder section, thereby realizing both wear resistance and the low-fuel consumption property.

In JP-A-2017-210077 (Patent Literature 2), there is disclosed that the volume of the base rubber layer at a portion covering an outer end in a tire axial direction of a belt is reduced and the approximately entire shoulder rib is formed by the cap rubber layer for preventing rib tear in a tread shoulder section.

However, when the ratio of the base rubber layer occupying the shoulder section is too high as in Patent Literature 1, the base rubber layer tends to be exposed at an early stage due to wear in a wear condition where a wear amount in the shoulder section is large. In general, the base rubber layer wears out quickly and has low resistance to external damage, therefore, it is necessary to replace the tire when the base rubber layer is exposed. Moreover, in a case where a lug groove provided in the shoulder section is deep, the base rubber layer is exposed in the lug groove and cracks tend to occur from a portion where the base rubber layer is exposed when contacting unevenness on a road surface or biting a stone.

On the other hand, when the volume of the base rubber layer is small as in Patent Literature 2, the effect of the low-fuel consumption property obtained by the base rubber layer with the low-heat generation property is impaired.

### SUMMARY OF THE INVENTION

In view of the above problems, an object of an embodiment of the present invention is to provide a pneumatic tire capable of preventing exposure of the base rubber layer at an early stage while improving the low-fuel consumption property.

A pneumatic tire according to an embodiment of the present invention includes a tread rubber provided in a tread section and a belt layer including a plurality of belts provided on an inner side in a tire radial direction of the tread rubber, in which the tread rubber includes a cap rubber layer having a tread surface contacting a road surface and a base rubber layer arranged on the inner side in the tire radial direction of the cap rubber layer, the belt layer includes a widest belt with the maximum width and an outermost belt arranged on the outermost side in the tire radial direction. An intersection point between an interface between the cap rubber layer and the base rubber layer and an outermost belt lateral reference line extending from an outer end in a tire axial direction of the outermost belt to the tire axial direction is positioned on an inner side in the tire axial direction than an intersection point between a normal line extending from an outer end in the tire axial direction of the widest belt to the tread surface and the outermost belt lateral reference line. And an outer end part in the tire axial direction of the cap rubber layer covers an outer end part in the tire axial direction of the base rubber layer and is terminated on the inner side in the tire radial direction than an outer end in the tire axial direction of the base rubber layer, and the outer end in the tire axial direction of the base rubber layer is positioned on an outer side in the tire axial direction than an end of the tread surface.

In the specification, dimensions and so on of respective parts of the pneumatic tire are values measured in a state where the pneumatic tire is fitted to a normal rim and filled with an internal pressure of 50 kPa unless otherwise noted. The normal rim includes rims prescribed for respective tires by standards in a standard system including standards to which tires belong, which corresponds to, for example, a standard rim in JATMA, “Design Rim” in TRA and “Measuring Rim” in ETRTO.

According to the embodiment, the outer end in the tire axial direction of the base rubber layer is set to be on the outer side in the tire axial direction than the end of the tread surface, thereby securing the volume of the base rubber layer. Moreover, the interface between the cap rubber layer and the base rubber layer is set to be on the inner side than the intersection point between the normal line extending from the outer end of the widest belt to the tread surface and the outermost belt lateral reference line, thereby suppressing exposure of the base rubber layer. Accordingly, it is possible to prevent exposure of the base rubber layer at an early stage while improving the low-fuel consumption property.

### BRIEF DESCRIPTION OF THE DRAWINGS

FIG. 1 is a half-sectional view showing a cross section in a tire width direction of a pneumatic tire according to one embodiment; and

FIG. 2 is an enlarged view of a relevant part of FIG. 1.

### DESCRIPTION OF EMBODIMENTS

Hereinafter, an embodiment will be explained with reference to the drawings.

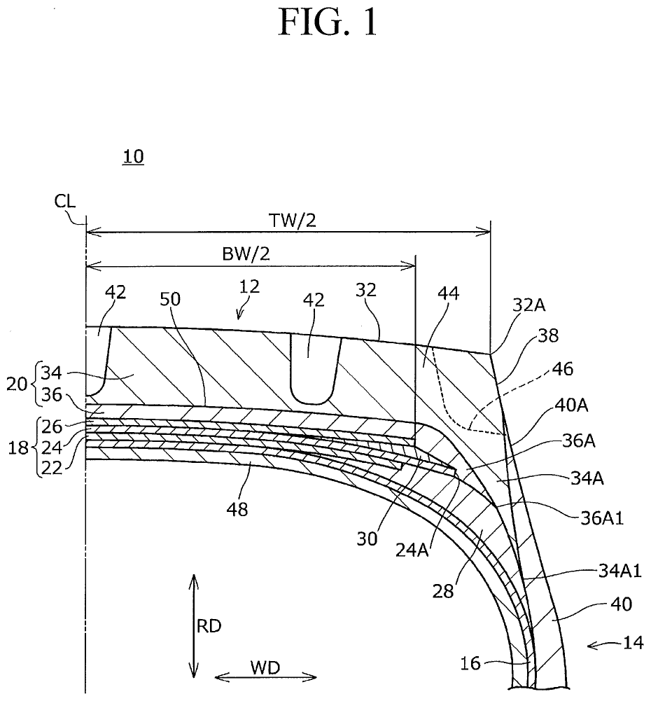

A pneumatic tire 10 according to one embodiment shown in FIG. 1 includes a tread section 12 forming a ground contact surface, a right and left pair of bead sections, and a right and left pair of sidewall sections 14 interposed between the tread section 12 and the bead sections. The pneumatic tire 10 according to the embodiment is a pneumatic tire for heavy load fitted to a truck, a bus and so on.

In the drawings, a reference sign CL denotes a tire equator plane corresponding to the center in the tire axial direction. In this example, the pneumatic tire 10 is symmetrical with respect to the tire equator plane CL.

Here, the tire axial direction is a direction parallel to a tire rotation axis, which is shown by a reference sign WD in the drawings. An inner side in the tire axial direction WD is a direction coming close to the tire equator plane CL, and an outer side in the tire axial direction WD is a direction going away from the tire equator plane CL. A tire radial direction is a direction perpendicular to the tire rotation axis, which is shown by a reference sign RD in the drawings. An inner side in the tire radial direction RD is a direction coming close to the tire rotation axis, and an outer side in the tire radial direction RD is a direction going away from the tire rotation axis. A tire circumferential direction is a direction on a circumference centered on the tire rotation axis.

The pneumatic tire 10 includes a carcass layer 16 extending in a toroidal shape between the pair of bead parts. The carcass layer 16 reaches the bead parts through the sidewall sections 14 on both sides from the tread section 12 and locked at the bead sections. The carcass layer 16 includes at least one carcass ply formed by carcass codes such as steel codes arranged substantially at right angles to the tire circumferential direction and covered with rubber.

In the tread section 12, a belt layer 18 is provided on the outer side in the tire radial direction RD of the carcass layer 16, and a tread rubber 20 is layered on the outer side in the tire radial direction RD of the belt layer 18.

The belt layer 18 includes a plurality of belts 22, 24 and 26 provided on the inner side in the tire radial direction RD of the tread rubber 20. The belts 22, 24 and 26 are formed by belt codes such as steel codes arranged at an angle inclined, for example, 10° to 35° with respect to the tire circumferential direction and covered with rubber. In this example, the belt layer 18 has a three-layer structure including three belts, which are a first belt 22, a second belt 24 and a third belt 26 in order from the inner side in the tire radial direction RD.

The first belt 22 is the innermost belt (hereinafter, referred to as an “innermost belt 22”) arranged in the innermost side in the tire radial direction RD. The second belt 24 is the widest belt (hereinafter, referred to as a “widest belt 24”) which is the widest in width (a dimension in a belt width, namely, in the tire axial direction WD of the belt). The third belt 26 is the outermost belt (hereinafter, referred to as an “outermost belt 26”) arranged on the outermost side in the tire radial direction RD.

The width of the widest belt 24 is not particularly limited and may be, for example, 0.80 to 0.95 times of a tread width TW. Widths of the innermost belt 22 and the outermost belt 26 are not particularly limited either and may be, for example, 0.80 to 0.95 times of the width of the widest belt 24.

The belt layer 18 is provided with belt cushion rubbers 28 with a triangular shape in cross section on the inner side in the tire radial direction RD on both ends thereof so that the both ends thereof are gradually separated from the carcass layer 16. Moreover, rubbers-under-outermost-belt 30 with a triangular shape in cross section are provided between the widest best 24 and the outermost belt 26 so that both end parts of both belts are gradually separated toward the outer side in the tire axial direction WD.

The tread rubber 20 has a two-layer structure including a cap rubber layer 34 having a tread surface 32 contacting a road surface and a base rubber layer 36 arranged on the inner side in the tire radial direction RD of the cap rubber layer 34.

The tread surface 32 is an outer peripheral surface of the tread section 12 forming the ground contact surface. The tread section 12 includes the tread surface 32 and a right and left pair of side surfaces 38, thereby forming a convex shape facing the outer side in the tire radial direction RD. An outer surface of the tread section 12 (specifically, the cap rubber layer 34) in the radial direction is the tread surface 32, and an outer surface in the tire axial direction (a so-called buttress surface) extending inward in the tire radial direction RD in a cliff shape from an end (outer end in the tire axial direction) 32A of the tread surface 32 is the side surface 38 (hereinafter, referred to as a “tire outer side surface 38”). The end 32A of the tread surface 32 is a tread ground contact end. The tread width TW is a dimension in the tire axial direction of the tread surface 32, which is a distance between ends 32A on both sides.

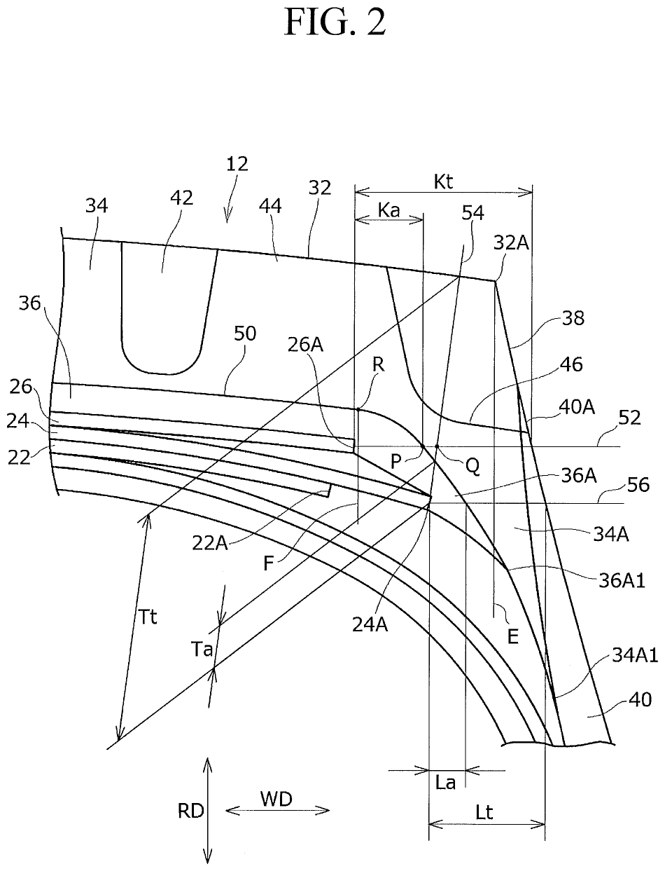

In the cap rubber layer 34, an outer end part 34A thereof in the tire axial direction covers an outer end part 36A in the tire axial direction of the base rubber layer 36 and is terminated on an inner side in the tire radial direction RD than an outer end 36A1 in the tire axial direction of the base rubber layer 36. That is, an outer end 34A1 in the tire axial direction of the cap rubber layer 34 is positioned on the outer side in the tire axial direction WD as well as on the inner side in the tire radial direction RD than the outer end 36A1 in the tire axial direction of the base rubber layer 36. Accordingly, the entire width of the base rubber layer 36 is covered with the cap rubber layer 34 and the base rubber layer 36 is not exposed in the tire outer side surfaces 38. The outer end part 36A in the tire axial direction of the base rubber layer 36 covers an outer end 24A in the tire axial direction of the widest belt 24 and is terminated so as to cross a later-described widest belt lateral reference line 56 (see FIG. 2) inward in the tire radial direction on the outer side in the tire axial direction WD of the outer end 24A.

In a sidewall rubber 40 arranged on the outside of the carcass layer 16 and in the side wall section 14, an outer end part 40A in the tire radial direction thereof extends to the tread section 12 so as to cover the outer end part 34A in the tire axial direction of the tread rubber 20 (specifically, the cap rubber layer 34). Accordingly, a portion adjacent to the end 32A of the tread surface 32 in the side surface 38 of the tread section 12 is formed of the cap rubber layer 34, and a portion adjacent to the inner side in the radial direction thereof is formed of the sidewall rubber 40.

Here, rubber with a lower loss tangent tan δ than that of the cap rubber layer 34 is used for the base rubber layer 36. For example, rubber with a tan δ in a range from 0.04 to 0.12 may be used for the base rubber layer 36, and rubber with a tan δ in a range from 0.10 to 0.22 may be used for the cap rubber layer 34.

Moreover, rubber with a higher hardness than that of the base rubber layer 36 is used for the cap rubber layer 34. For example, rubber with a hardness in a range from 60 to 70 may be used for the cap rubber layer 34 and rubber with a hardness in a range from 55 to 62 may be used for the base rubber layer 36.

When the low-heat generation rubber is used for the base rubber layer 36, the low-fuel consumption property can be improved and heat generation in the vicinity of the end part of the belt layer 18 can be suppressed to thereby improve durability of the belt layer 18. Moreover, rubber that is hardly worn out and has high resistance to cutting and chipping is used for the cap rubber layer 34, thereby improving wear resistance and resistance to external damage (crack resistance).

In the present specification, the tan δ of rubber is a value measured by using a viscoelasticity spectrometer while setting a temperature to 70° C., setting a frequency to 10 Hz, setting an initial strain to 10% and setting a dynamic strain to 1%. The rubber hardness is durometer hardness in JIS K6253-1-2012 3.2, which is measured under an atmosphere of 23° C. by using a type A durometer for general rubber (middle hardness).

A plurality of (three in this example) circumferential main grooves 42 extending in the tire circumferential direction are provided on the tread surface 32, thereby partitioning a plurality of land sections. On a tread shoulder section 44 as a land section on the outer side in the tire axial direction WD than the circumferential main groove 42 arranged on the outermost side in the tire axial direction WD, lug grooves 46 extending in the tire axial direction WD are provided at an interval in the tire circumferential direction. The lug groove 46 is a lateral groove in which one end opens at the end 32A of the tread surface 32 and the other end is terminated within the tread shoulder section 44.

A reference sign 48 denotes an inner liner as an air permeation resistance layer provided in the entire tire inner surface.

In the pneumatic tire 10 according to the embodiment, arrangement, dimensions and so on of respective parts in the tread section 12 are set as described below on the cross section in the tire axial direction in a state of normal rim assembly shown in FIG. 1 and FIG. 2. Here, the cross section in tire axial direction is a cross section along the tire axial direction WD, which can be also expressed as a cross section in a direction of a tire-meridian line. The state of normal rim assembly is a state where the pneumatic tire 10 is fitted to a normal rim and filled with an internal pressure of 50 kPa.

(1) An intersection point P between an interface 50 between the cap rubber layer 34 and the base rubber layer 36 and an outermost belt lateral reference line 52 extending from an outer end 26A in the tire axial direction of the outermost belt 26 to the tire axial direction WD is positioned on the inner side in the tire axial direction than an intersection point Q between a normal line 54 extending from the outer end 24A in the tire axial direction of the widest belt 24 to the tread surface 32 and the outermost belt lateral reference line 52.

Here, the outermost belt lateral reference line 52 is a straight line extending in parallel to the tire axial direction WD from a thickness center of the outer end 26A in the tire axial direction. The normal line 54 is a normal line at one point on the tread surface 32, which passes through a thickness center of the outer end 24A in the tire axial direction, which crosses the tread surface 32 at right angles on the inner side in the tire axial direction WD than the end 32A of the tread surface 32. The intersection point P is an intersection point between the interface 50 and the outermost belt lateral reference line 52, and the intersection point Q is an intersection point between the normal line 54 and the outermost belt lateral reference line 52.

As described in (1), the intersection point P is set on the inner side in the tire axial direction WD than the intersection point Q on the outermost belt lateral reference line 52, therefore, the interface 50 between the cap rubber layer 34 and the base rubber layer 36 is lowered at the tread shoulder section 44 (particularly in a portion close to the outer side in the tire axial direction WD). Accordingly, even in a wear condition where a wear amount in the tread shoulder section 44 is large, exposure of the base rubber layer 36 at an early stage can be prevented and wear resistance can be improved. Furthermore, even when the lug groove 46 provided in the tire shoulder section 44 is deep, the base rubber layer 36 is not easily exposed in the lug groove 46, and occurrence of cracks in the lug groove 46 can be suppressed.

(2) The outer end 36A1 in the tire axial direction of the base rubber layer 36 is positioned on the outer side in the tire axial direction WD than the end 32A of the tread surface 32. That is, the outer end 36A1 of the base rubber layer 36 is positioned on the outer side in the tire axial direction WD than a position E in the tire axial direction of the tread ground contact end 32A.

When the outer end 36A1 of the base rubber layer 36 is set to the outer side in the tire axial direction WD than the tread ground contact end 32A, the volume of the base rubber layer 36 can be secured while the interface 50 between the cap rubber layer 34 and the base rubber layer 36 is suppressed to be low in the tread shoulder section 44. Accordingly, the low-fuel consumption property can be improved while preventing early exposure of the base rubber layer 36.

(3) On the widest belt lateral reference line 56 extending from the outer end 24A in the tire axial direction of the widest belt 24 to the tire axial direction WD, a ratio La/Lt between a thickness La of the base rubber layer 36 and a distance Lt from the outer end 24A in the tire axial direction of the widest belt 24 to the tire outer side surface 38 is 0.10 to 0.50. Here, the widest belt lateral reference line 56 is a straight line extending in parallel to the tire axis direction WD from a thickness center of the outer end 24A in the tire axial direction.

When La/Lt is 0.10 or more, the low-heat generation property due to the base rubber layer 36 can be increased, which is effective for improving low-fuel consumption property and durability. When La/Lt is 0.50 or less, the effect of suppressing exposure of the base rubber layer 36 at an early stage can be increased. More preferably, the lower limit of La/Lt is 0.20 or more and the upper limit is 0.40 or less, 0.35 or less, or 0.30 or less.

(4) On the outermost belt lateral reference line 52, a ratio Ka/Kt between a thickness Ka of the base rubber layer 36 and a distance Kt from the outer end 26A in the tire axial direction of the outermost belt 26 to the tire outer side surface 38 is 0.10 to 0.45.

When Ka/Kt is 0.10 or more, the low-heat generation property due to the base rubber layer 36 can be increased, which is effective for improving low-fuel consumption property and durability. When Ka/Kt is 0.45 or less, the effect of suppressing exposure of the base rubber layer 36 at an early stage can be increased. More preferably, the lower limit of Ka/Kt is 0.20 or more and the upper limit is 0.40 or less, 0.35 or less, or 0.30 or less.

(5) On the normal line 54, a ratio Ta/Tt between a thickness Ta of the base rubber layer 36 and a distance Tt from the outer end 24A in the tire axial direction of the widest belt 24 to the tread surface 32 is 0.10 to 0.30.

When Ta/Tt is 0.10 or more, the low-heat generation property due to the base rubber layer 36 can be increased, which is effective for improving low-fuel consumption property and durability. When Ta/Tt is 0.30 or less, the effect of suppressing exposure of the base rubber layer 36 at an early stage can be increased. More preferably, the lower limit of Ta/Tt is 0.15 or more and the upper limit is 0.25 or less.

(6) A position F of a changing point R in the tire axial direction on the interface 50 as a starting point where the thickness of the cap rubber layer 34 starts to increase in the tread shoulder section 44 is positioned within a distance range of 2.5% of the outermost belt width BW (see FIG. 1) from the outer end 26A in the tire axial direction of the outermost belt 26.

The thickness of the cap rubber layer 34 mentioned here is a thickness of the cap rubber layer 34 in the tire radial direction RD, which is a distance between the tread surface 32 and the interface 50 in the tire radial direction RD (thicknesses at portions other than the groove). The outermost belt width BW is a distance (distance in the tire axial direction) between both ends in the tire axial direction WD of the outermost belt 26.

The changing point R of the interface 50 is a point where the thickness of the cap rubber layer 34 starts to increase to the outer side in the tire axial direction WD. That is, there is a point where the thickness of the cap rubber layer 34 starts to increase from a fixed value toward the outer side in the tire axial direction WD as a curvature of the interface 50 changes in the tread shoulder section 44, and the point where the curvature changes is the changing point R. Therefore, the changing point R may be referred to as a curvature changing point. Accordingly, the thickness of the cap rubber layer 34 is constant in the inner side of the changing point R in the tire axial direction WD, and the thickness of the cap rubber layer 34 is increased toward the outer side in the tire axial direction WD until reaching the tread ground contact end 32A on the outer side of the changing point R in the tire axial direction WD.

The above (6) means that the position F of the changing point R in the tire axial direction approximately corresponds to the outer end 26A in the tire axial direction of the outermost belt 26. That is, the position F of the changing point R in the tire axial direction is set within a range of ±2.5% of the outermost belt width BW as the width of the outermost belt 26 centering on the position of the outer end 26A in the tire axial direction. When the position F is set as described above, it becomes easy to realize both suppression of early exposure of the base rubber layer 36 and improvement of the low-fuel consumption property.

(7) The position F of the changing point R in the tire axial direction on the interface 50 is on the outer side in the tire axial direction WD than the outer end 22A in the tire axial direction of the innermost belt 22. Accordingly, it is possible to increase the volume of the base rubber layer 36 and increase the low-fuel consumption property.

### EXAMPLE

Examples and comparative examples for a pneumatic radial tire for heavy load with a tire size: 225/70R19.5 were obtained. Basic structures of respective tires in examples and comparative examples are as described in the above embodiment. Tires were experimentally produced by setting specifications as shown in Table 1 below. In all examples and comparative examples, rubber with tan δ 0.15 and rubber hardness 65 was used for the cap rubber layer 34, and rubber with tan δ 0.08 and rubber hardness 59 was used for the base rubber layer 36. Concerning respective trial tires, the low-fuel consumption property, crack resistance, durability and wear resistance were evaluated. Evaluation methods are as follows.

Low-fuel consumption property: rolling resistances were measured in conditions of a rim size (6.75×19.5), an internal pressure (760 kPa), a vertical load (15.0 kN) and speed (80 km/h), and reciprocals of the rolling resistances were evaluated by indexes regarding values of Comparative Example 2 as 100. The larger the index is, the smaller the rolling resistance, and the more excellent the low-fuel consumption property is.

Crack resistance: tires were allowed to run on a drum in conditions of the rim size (6.75×19.5), the internal pressure (760 kPa), the vertical load (17.7 kN) and speed (40 km/h), and traveling times until a crack occurs in the lug groove were evaluated by indexes regarding values of Comparative Example 2 as 100. The larger the index is, the longer the traveling time is, and the more excellent the crack resistance is.

Durability: tires were allowed to run on a drum in conditions of the rim size (6.75×19.5), the internal pressure (760 kPa), the vertical load (26.5 kN) and speed (40 km/h), and travelling time until damage occurs in the tread section was evaluated by indexes regarding values of Comparative Example 2 as 100. The larger the index is, the longer the traveling time is, and the more excellent the durability is.

Wear resistance: tires were fitted to a truck loaded so that a load per one tire was 17.7 kN and allowed to travel for 200,000 km in conditions of the rim size (6.75×19.5) and the internal pressure (760 kPa). Then, wear amounts were calculated by measuring groove depths, and reciprocals of average values were evaluated by indexes regarding values of Comparative Example 2 as 100. The larger the index is, the smaller the wear amount is, and the more excellent the wear resistance is.

TABLE 1

| | Example 1 | Example 2 | Example 3 | Example 4 | Example 5 | Example 6 |
|---|---|---|---|---|---|---|
| Distance between outermost belt | 8.5 | 1.8 | 2.2 | 10.0 | 10.4 | 8.5 |
| end and intersection point P on | | | | | | |
| outermost belt lateral reference line | | | | | | |
| (mm) | | | | | | |
| Distance between outermost belt | 10.5 | 10.5 | 10.5 | 10.5 | 10.5 | 10.5 |
| end and intersection point Q on | | | | | | |
| outermost belt lateral reference line | | | | | | |
| (mm) | | | | | | |
| Distance in tire axial direction from | 97.0 | 97.0 | 97.0 | 97.0 | 97.0 | 97.0 |
| tire equator plane to outer end in | | | | | | |
| axial direction of base rubber layer | | | | | | |
| (mm) | | | | | | |
| Distance in tire axial direction from | 95.0 | 95.0 | 95.0 | 95.0 | 95.0 | 95.0 |
| tire equator plane to tread ground | | | | | | |
| contact end (mm) | | | | | | |
| La/Lt | 0.25 | 0.08 | 0.1 | 0.5 | 0.55 | 0.25 |
| Ka/Kt | 0.25 | 0.08 | 0.1 | 0.45 | 0.47 | 0.25 |
| Ta/Tt | 0.2 | 0.08 | 0.1 | 0.3 | 0.35 | 0.2 |
| Distance in tire axial direction from | 78.0 | 73.0 | 76.0 | 78.0 | 81.0 | 73.0 |
| tire equator plane to changing point | | | | | | |
| R of base rubber layer (mm) | | | | | | |
| Distance in tire axial direction from | 77.0 | 77.0 | 77.0 | 77.0 | 77.0 | 77.0 |
| tire equator plane to outermost belt | | | | | | |
| end (mm) | | | | | | |
| Distance in tire axial direction from | 75.0 | 75.0 | 75.0 | 75.0 | 75.0 | 75.0 |
| tire equator plane to innermost belt | | | | | | |
| end (mm) | | | | | | |
| Evaluation | | | | | | |
| Low-fuel consumption property | 118 | 109 | 112 | 124 | 129 | 114 |
| Crack resistance | 100 | 100 | 105 | 95 | 93 | 103 |
| Durability | 118 | 109 | 112 | 124 | 129 | 114 |
| Wear resistance | 100 | 100 | 100 | 95 | 93 | 103 |

| | | | | Comparative | Comparative |
|---|---|---|---|---|---|
| | Example 7 | Example 8 | Example 9 | Example 1 | Example 2 |
| Distance between outermost belt | 8.5 | 8.5 | 8.5 | 11.0 | 5.0 |
| end and intersection point P on | | | | | |
| outermost belt lateral reference line | | | | | |
| (mm) | | | | | |
| Distance between outermost belt | 10.5 | 10.5 | 10.5 | 10.5 | 10.5 |
| end and intersection point Q on | | | | | |
| outermost belt lateral reference line | | | | | |
| (mm) | | | | | |
| Distance in tire axial direction from | 97.0 | 97.0 | 97.0 | 97.0 | 93.0 |
| tire equator plane to outer end in | | | | | |
| axial direction of base rubber layer | | | | | |
| (mm) | | | | | |
| Distance in tire axial direction from | 95.0 | 95.0 | 95.0 | 95.0 | 95.0 |
| tire equator plane to tread ground | | | | | |
| contact end (mm) | | | | | |
| La/Lt | 0.25 | 0.25 | 0.25 | 0.5 | 0.15 |
| Ka/Kt | 0.25 | 0.25 | 0.25 | 0.45 | 0.15 |
| Ta/Tt | 0.2 | 0.2 | 0.2 | 0.3 | 0.15 |
| Distance in tire axial direction from | 74.0 | 80.0 | 81.0 | 80.0 | 78.0 |
| tire equator plane to changing point | | | | | |
| R of base rubber layer (mm) | | | | | |
| Distance in tire axial direction from | 77.0 | 77.0 | 77.0 | 77.0 | 77.0 |
| tire equator plane to outermost belt | | | | | |
| end (mm) | | | | | |
| Distance in tire axial direction from | 75.0 | 75.0 | 75.0 | 75.0 | 75.0 |
| tire equator plane to innermost belt | | | | | |
| end (mm) | | | | | |
| Evaluation | | | | | |
| Low-fuel consumption property | 115 | 120 | 121 | 126 | 100 |
| Crack resistance | 102 | 98 | 97 | 80 | 100 |
| Durability | 115 | 120 | 121 | 126 | 100 |
| Wear resistance | 102 | 98 | 97 | 80 | 100 |

Results are as shown in Table 1. In Comparative Example 2, the outer end 36A1 in the tire axial direction of the base rubber layer 36 is positioned on the inner side in the tire axial direction WD than the tread ground contact end 32A. Accordingly, the volume of the base rubber layer 36 with the low-heat generation property was small and the low-heat generation property was low in Comparative Example 2, therefore, the low-fuel consumption property and durability were inferior. In Comparative Example 1, the intersection point P between the outermost belt lateral reference line 52 and the interface 50 is positioned on the outer side in the tire axial direction WD than the intersection point Q between the outermost belt lateral reference lint 52 and the normal line 54. Accordingly, the low-fuel consumption property and durability were excellent in Comparative Example 1, however, the base rubber layer 36 was exposed at an early stage due to wear of the tread rubber 20, and the crack resistance and wear resistance were inferior.

On the other hand, in Examples 1 to 9, the outer end 36A1 in the tire axial direction of the base rubber layer 36 is positioned on the outer side in the tire axial direction WD than the tread ground contact end 32A as well as the intersection point P between the outermost belt lateral reference line 52 and the interface 50 is positioned on the inner side in the tire axial direction WD than the intersection point Q between the outermost belt lateral reference lint 52 and the normal line 54. Accordingly, the volume of the base rubber layer 36 was increased to thereby improve the low-fuel consumption property and durability in Examples 1 to 9 as compared with Comparative Example 2. Moreover, wear of the base rubber layer 36 at the early stage can be suppressed, and deterioration in crack resistance and wear resistance could be suppressed as compared with Comparative Example 1. Accordingly, the low-fuel consumption property, the crack resistance, the durability and the wear resistance could be improved in a balanced manner.

Some embodiments of the present invention have been explained above. These embodiments are cited as examples and do not intend to limit the scope of the invention. These novel embodiments can be achieved in other various forms and various omissions, replacements and alterations may occur within the scope not departing from the gist of the invention.

What is claimed is:

1. A pneumatic tire comprising:
a tread rubber provided in a tread section; and
a belt layer comprising a plurality of belts provided on an inner side in a tire radial direction of the tread rubber,
wherein the tread rubber includes a cap rubber layer having a tread surface contacting a road surface and a base rubber layer arranged on the inner side in the tire radial direction of the cap rubber layer,
the belt layer includes a widest belt with the maximum width and an outermost belt arranged on the outermost side in the tire radial direction,
an intersection point between an interface between the cap rubber layer and the base rubber layer and an outermost belt lateral reference line extending from an outer end in a tire axial direction of the outermost belt to the tire axial direction is positioned on an inner side in the tire axial direction than an intersection point between a normal line extending from an outer end in the tire axial direction of the widest belt to the tread surface and the outermost belt lateral reference line, and
an outer end part in the tire axial direction of the cap rubber layer covers an outer end part in the tire axial direction of the base rubber layer and is terminated on the inner side in the tire radial direction than an outer end in the tire axial direction of the base rubber layer, and the outer end in the tire axial direction of the base rubber layer is positioned on an outer side in the tire axial direction than an end of the tread surface.

2. The pneumatic tire according to claim 1,
wherein, a ratio La/Lt between a thickness La of the base rubber layer and a distance Lt from the outer end in the tire axial direction of the widest belt to an tire outer side surface is 0.10 to 0.50 on a widest belt lateral reference line extending from the outer end in the tire axial direction of the widest belt to the tire axial direction.

3. The pneumatic tire according to claim 1,
wherein a ratio Ka/Kt between a thickness Ka of the base rubber layer and a distance Kt from the outer end in the tire axial direction of the outermost belt to an tire outer side surface is 0.10 to 0.45 on the outermost belt lateral reference line.

4. The pneumatic tire according to claim 1,
wherein a ratio Ta/Tt between a thickness Ta of the base rubber layer and a distance Tt from the outer end in the tire axial direction of the widest belt to the tread surface is 0.10 to 0.30 on the normal line.

5. The pneumatic tire according to claim 1,
wherein a position of a changing point in the tire axial direction on the interface as a starting point where a thickness of the cap rubber layer starts to increase in a tread shoulder section is positioned within a distance range of 2.5% of an outermost belt width from the outer end in the tire axial direction of the outermost belt.

6. The pneumatic tire according to claim 1,
wherein the belt layer includes an innermost belt arranged in the innermost side in the tire radial direction with the widest belt and the outermost belt, and
a position of a changing point in the tire axial direction on the interface as a starting point where the thickness of the cap rubber layer starts to increase in a tread shoulder section is positioned on the outer side in the tire axial direction than an outer end in the tire axial direction of the innermost belt.
